(19) United States
(12) Patent Application Publication
(10) Pub. No.: US 2014/0086734 A1
(43) Pub. Date: Mar. 27, 2014

(54) METHOD AND SYSTEM FOR FABRICATING COMPOSITE CONTAINMENT CASINGS

(71) Applicant: Ming Xie, Beavercreek, OH (US)

(72) Inventor: Ming Xie, Beavercreek, OH (US)

(73) Assignee: General Electric Company, Schenectady, NY (US)

(21) Appl. No.: 13/624,253

(22) Filed: Sep. 21, 2012

(51) Int. Cl. B32B 37/14; F01D 25/24

(52) U.S. Cl. 415/200; 415/182.1; 156/196

(57) ABSTRACT

A system and a method for making a composite containment casing are provided. The method includes providing a mandrel, applying at least one ply of a material about the mandrel to form a first annular facesheet, applying a plurality of core segments surrounding the first facesheet, forming a casing surrounding the core segments. and curing the facesheet, core segments, and casing together forming a unitary composite containment casing. Alternatively, the facesheet and the core segments can be formed and cured first, and then form and cure the outer casing to complete the manufacture of a unitary composite containment casing,

### BACKGROUND OF THE INVENTION

The field of the invention relates generally to a system and methods for making composite containment casings, and more specifically, to methods for making composite fan casings having greater stiffness, and having fewer manufacturing steps.

In gas turbine engines, such as aircraft engines, air is drawn into the front of the engine, compressed by a shaft-mounted compressor, and mixed with fuel in a combustor. The mixture is then burned and the hot exhaust gases are passed through a turbine mounted on the same shaft. The flow of combustion gas expands through the turbine which in turn spins the shaft and provides power to the compressor. The hot exhaust gases are further expanded through nozzles at the back of the engine, generating powerful thrust, which drives the aircraft forward.

At least some known fan containment case assemblies include segmented composite sandwich panels made separately from each other and the case assembly and then bonded on to the containment case inner surface. These segmented composite sandwich panels provide an air flowpath and sometimes other functions such as acoustic treatment to reduce engine noise. Similar concepts and manufacturing processes are used on both metallic and composite fan cases, and used by most manufacturers. Such a process of assembly is costly in terms of labor and time to produce the final casing. Moreover, such a process produces a less stiff casing due to many pieces being bonded together to form the final casing.

### BRIEF DESCRIPTION OF THE INVENTION

In one embodiment, a method for making a composite containment casing includes providing a mandrel, applying at least one ply of a material about the mandrel to form a first annular facesheet, applying a plurality of core segments surrounding the first facesheet, forming a casing surrounding the core segments using an automated fiber placement (AFP) process, and curing the facesheet, core segments, and casing together forming a unitary composite containment casing.

In another embodiment, a method of forming a composite containment casing assembly includes forming a first annular radially inner facesheet using an automated fiber placement (AFP) process, installing a core surrounding the facesheet forming a core assembly, forming a radially outer casing surrounding the core using the AFP process, curing the casing assembly.

In yet another embodiment, a composite containment casing system includes a first radially inner annular facesheet layer configured to surround a gas turbine engine duct, a core assembly surrounding said facesheet layer, and a casing structure wound around the core assembly, said facesheet layer, core assembly, and said casing structure cured together to form a unitary containment casing system.

### BRIEF DESCRIPTION OF THE DRAWINGS

FIGS. 1-5 show exemplary embodiments of the methods and system described herein.

FIG. 1 is a schematic representation of one embodiment of a conventional gas turbine engine that generally includes a fan assembly and a core engine.

FIG. 2 is a side cross-sectional view of a portion of composite fan containment casing in accordance with an exemplary embodiment of the present invention.

FIG. 3 is a flow chart of a method of forming a composite containment casing in accordance with an exemplary embodiment of the present invention.

FIG. 4 is a flow chart of a method of forming a composite containment casing in accordance with an exemplary embodiment of the present invention.

FIG. 5 is a flow chart of a method of forming a composite containment casing in accordance with an exemplary embodiment of the present invention.

### DETAILED DESCRIPTION OF THE INVENTION

The following detailed description illustrates embodiments of the invention by way of example and not by way of limitation. It is contemplated that the invention has general application to forming of composite structures in industrial, commercial, and residential applications.

As used herein, an element or step recited in the singular and preceded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

With a composite fan containment case, it is now feasible to integrate the sandwich panels as part of the fan containment case design, and to fabricate them together with the fan containment case. In various embodiments, of the present disclosure automated fiber placement (AFP) is used to automatically place multiple individual tows formed of, for example, a pre-impregnated composite material onto a mandrel at high speed, using a numerically controlled, articulating robotic placement head to dispense, clamp, cut and restart as many as 32 tows simultaneously. Advantages of fiber placement include processing speed, reduced material scrap and labor costs, parts consolidation and improved part-to-part uniformity. However, the general design and manufacturing concepts described here are applicable to other manufacturing processes such as hand layup process.

In one embodiment, the sandwich panels are fabricated as a full 360° casing structure. The sandwich structure is inspected and cured separately from the casing or the casing is formed with the sandwich structure and the entire assembly is cured together forming a unitary sandwich panel/casing structure. The casing and other portions of the structure are formed of a pre-impregnated composite material laid using an automated fiber placement or any other appropriate method.

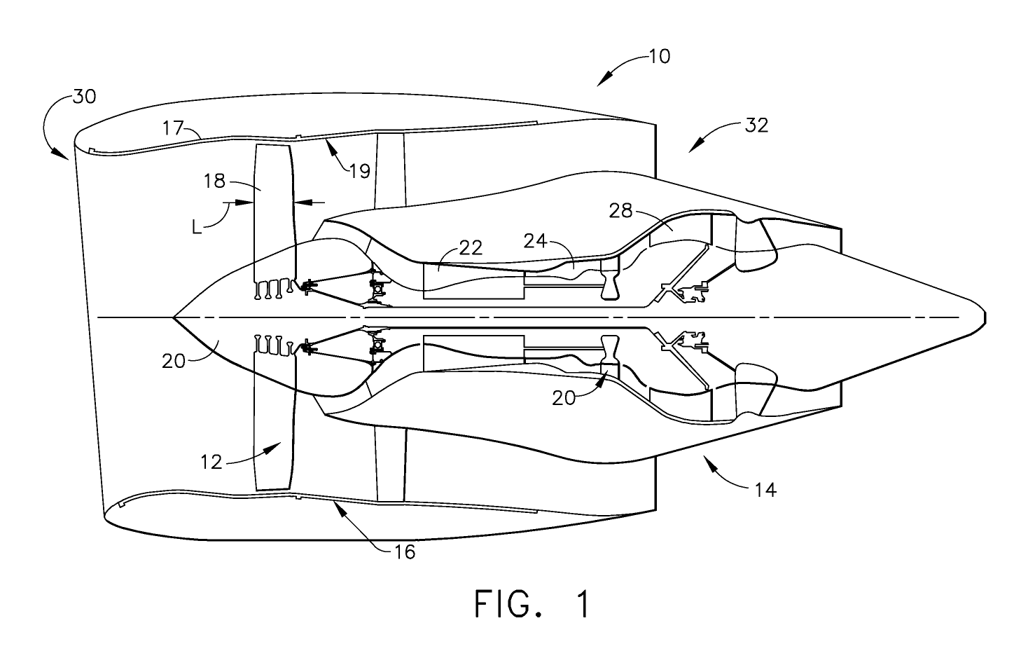

FIG. 1 is a schematic representation of one embodiment of a conventional gas turbine engine 10 that generally includes a fan assembly 12 and a core engine 14. Fan assembly 12 may include a composite fan casing 16 having a body 17, and an array of fan blades 18 extending radially outwardly from a rotor disc 20. Core engine 14 may include a high-pressure compressor 22, a combustor 24, a high-pressure turbine 26 and a low-pressure turbine 28. Engine 10 has an intake end 30 and an exhaust end 32.

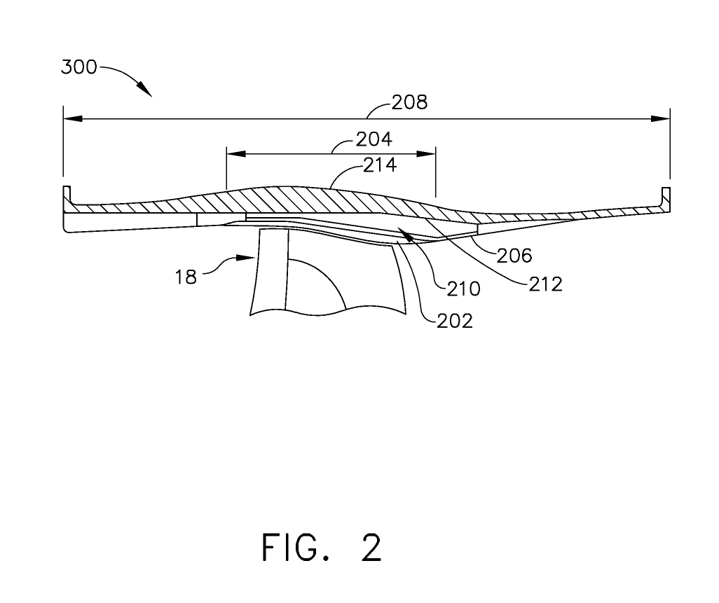

FIG. 2 is a side cross-sectional view of a portion 300 of composite fan containment casing 16 in accordance with an exemplary embodiment of the present invention. In the exemplary embodiment, a layer of abradable material 202 is coupled to casing 16 and is configured to extend axial length 204 outboard of fan blade 18. Casing 16 includes first layer 206 formed by wrapping layers of tow around a mandrel (not shown) shaped complementary to a desired casing inside surface using for example, an automated fiber placement (AFP) process. Layer 206 may also be formed of a variable thickness over the axial extent of layer 206. Moreover, layer 206 may extend the entire axial length 208 or may only extend over a partial distance of length 208.

Layer 206 may be cured separately from other casing components or may be cured after other casing components have been coupled to layer 206. A layer of non-composite filler material 210 is applied to a radially outer surface of layer 206. Layer 210 may be applied in a manual process and may be coupled to layer 206 using adhesives or mechanical means. Layer 210 usually comprises circumferential segments of material positioned around layer 206 of casing 16. Each segment of layer 210 may extend along the entirety of length 208 or may extend only partially along length 208. Moreover, layer 210 may be formed of various smaller “tiles” of material positioned in an overlapping and/or abutting configuration.

Casing 16 may also include a second facesheet layer 212. Layer 212 is also applied using an AFP process around layer 210. In various embodiments, layers 206, 210, and 212 are cured together forming a single annular body comprising a composite shell surrounding the filler material.

The assembly process is monitored by inspections of the components of casing 16 at intermediate steps during the process. For example, when layer 206 is fabricated from segments, each segment may be inspected after curing and any not meeting manufacturing tolerances may be discarded or reworked. Generally, after each curing step, the solid component is inspected for defects. Such inspections can reduce the wastage of defects in the process, but also may increase manufacturing costs and structural strength of the final casing 16. Generally, when more components are cured together into a unitary piece, the stronger the piece is. When more components are formed separately and subsequently bonded together, the less stiff and/or strong the final casing structure will be.

Casing 16 also includes a radially outer casing layer 214 formed of composite material using the AFP process. The casing is built up to desired outer dimensions and the entire casing assembly is cured to form a unitary annular structure suitable for housing a gas turbine engine.

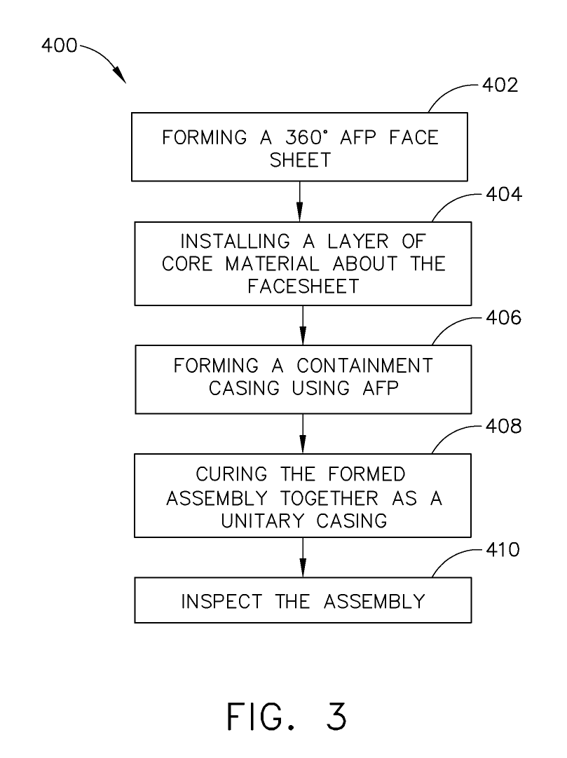

FIG. 3 is a flow chart of a method 400 of forming a composite containment casing in accordance with an exemplary embodiment of the present invention. In the exemplary embodiment, method 400 includes forming 402 a facesheet extending 360° about a mandrel. In one embodiment, the facesheet is formed by manually positioning a plurality of layers of tow pre-impregnated with a resin, such as an epoxy, around the mandrel. In various embodiments, the facesheet is formed using an automated process, such as, an automated fiber placement (AFP) process. Method 400 also includes installing 404 a layer of core material surrounding the facesheet layer. The core material is generally a honeycomb or foam material, but may also include open structures, such as a truss structure. The layer of core material may be installing manually surrounding the facesheet and may be adhered to the facesheet by adhesives or other bonding process. A containment casing is formed 406 about the layer of core material using the AFP process to build up a layer of composite material, for example, tows pre-impregnated with resin. The build up process may apply an axially variable thickness of composite material to form an outer surface of the casing matching predetermined specifications. Method 400 includes curing 408 the entire casing structure together to form a unitary casing structure. The cured casing structure is then inspected 410 to ensure quality of the casing forming process.

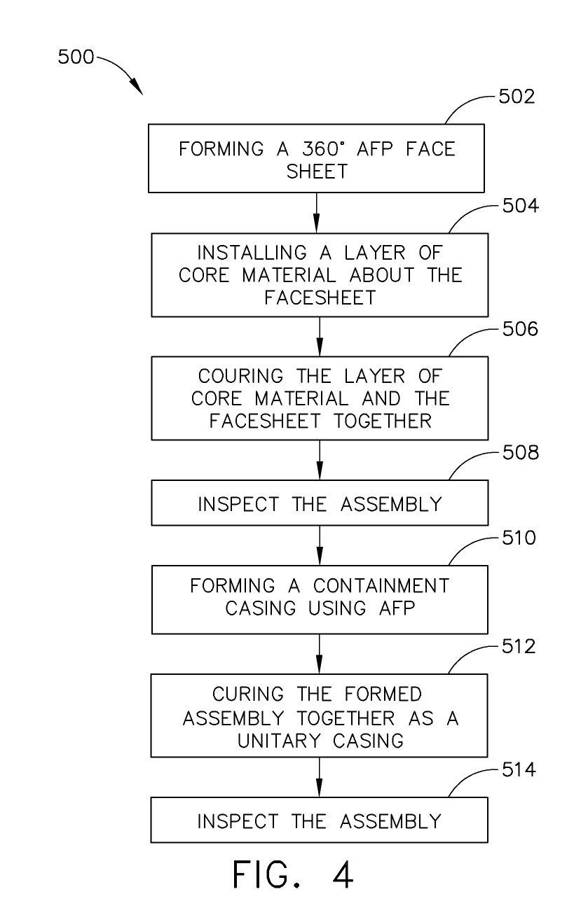

FIG. 4 is a flow chart of a method 500 of forming a composite containment casing in accordance with an exemplary embodiment of the present invention. In the exemplary embodiment, method 500 includes forming 502 a facesheet extending 360° about a mandrel. In one embodiment, the facesheet is formed by manually positioning a plurality of layers of tow pre-impregnated with resin around the mandrel. In various embodiments, the facesheet is formed using an automated process, such as, an automated fiber placement (AFP) process. Method 500 also includes installing 504 a layer of core material surrounding the facesheet layer. The core material is generally a honeycomb or foam material, but may also include open structures, such as a truss structure. The layer of core material may be installing manually surrounding the facesheet and may be adhered to the facesheet by adhesives or other bonding process. A second facesheet may be applied to the outer surface of the layer of core material for stability of the layers and the facesheets and core material are then cured 506 together to form a unitary interior casing portion. After the assembly is inspected 508, a containment casing is formed 510 about the assembly using the AFP process to build up a layer of composite material, for example, tows pre-impregnated with resin. The build up process may apply an axially variable thickness of composite material to form an outer surface of the casing matching predetermined specifications. Method 500 includes curing 512 the entire casing structure together to form a unitary casing structure. The cured casing structure is then inspected 514 to ensure quality of the casing forming process.

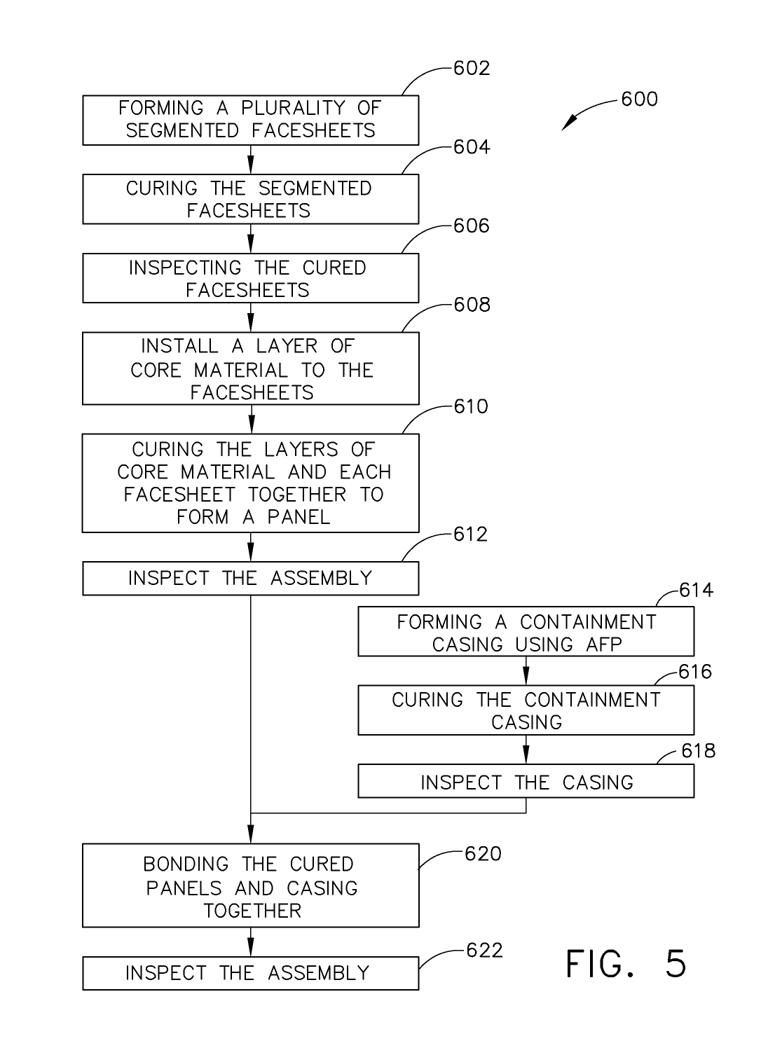

FIG. 5 is a flow chart of a method 600 of forming a composite containment casing in accordance with an exemplary embodiment of the present invention. In the exemplary embodiment, method 600 includes forming 602 a segmented facesheet that extends less than 360° circumferentially. Each segmented facesheet may be formed individually and cured 604 separately from others of the plurality of facesheets needed to circumscribe the fan duct when the engine is fully assembled. In one embodiment, the facesheet is formed by manually positioning a plurality of layers of tow pre-impregnated with resin. In various embodiments, the segmented facesheet portions are formed using an automated process, such as, an automated fiber placement (AFP) process. Method 600 also includes inspecting 606 the cured facesheets and installing 608 a layer of core material to the facesheet layers found to meet quality requirements. The core material is generally a honeycomb or foam material, but may also include open structures, such as a truss structure. The layer of core material is installed manually to the facesheet and may be adhered to the facesheet by adhesives or other bonding process. The facesheet and core material are then cured 610 together to form a panel. A containment casing is formed 614 about the mandrel using the AFP process to build up a layer of composite material, for example, tows pre-impregnated with resin. The build up process may apply an axially variable thickness of composite material to form an outer surface of the casing matching predetermined specifications. Method 600 further includes curing 616 the outer casing structure separately from the panels to form a cured casing structure. The cured casing structure is then inspected 618 to ensure quality of the casing forming process. Method 600 includes bonding 620 the cured panels to a radially inner surface of the cured casing structure and inspecting the entire casing 16.

Method 400 creates a potentially lower cost casing structure than methods 500 or 600 in that the major components are formed in sequence without a curing or inspection step until the end of the process where the entire structure is cured together and then inspected. This permits savings in fabrication on the order of approximately 20% over other methods. However, the drawback is if the final structure does not meet inspection standards the entire assembly must be rejected or reworked, potentially causing great loss of time and financial resources. Method 600 includes curing and inspection steps at many points in the fabrication process allowing for rejection of nonconforming components early in the fabrication process, which may increase costs and manufacturing time. Moreover, the processes described in methods 400 and 500 also provide for a stiffer and stronger casing than method 600.

The above-described embodiments of a methods and system of forming a composite containment casing assembly provides a cost-effective and reliable means for providing additional stiffness, strength and containment capability to engine casings over current segmented panel designs. More specifically, the methods and system described herein facilitate reducing man-hour assembly requirements. In addition, the above-described methods and system facilitate forming a stiffer and stronger casing structure. As a result, the methods and system described herein facilitate forming lighter and stronger casings for rotatable machines in a cost-effective and reliable manner.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method for making a composite containment casing, said method comprising:
providing a mandrel;
applying at least one ply of a material about the mandrel to form a first annular facesheet;
applying a plurality of core segments surrounding the first facesheet;
forming a casing surrounding the core segments; and
curing the facesheet, core segments, and casing together forming a unitary composite containment casing.

2. A method in accordance with claim 1, wherein applying at least one ply of a material about the mandrel to form an annular facesheet comprises applying at least one ply of a material about the mandrel using an AFP process.

3. A method in accordance with claim 1, wherein applying a plurality of core segments surrounding the facesheet comprises applying a plurality of core segments that comprise a plurality of core layers.

4. A method in accordance with claim 1, wherein applying a plurality of core segments that comprise core layers comprising any of a cell configuration, a columnar configuration, or a truss configuration.

5. A method in accordance with claim 1, wherein applying a plurality of core segments surrounding the first facesheet comprises bonding the plurality of core segments to the facesheet.

6. A method in accordance with claim 1, wherein applying a plurality of core segments surrounding the facesheet comprises applying a second facesheet surrounding the plurality of core segments.

7. A method in accordance with claim 6, further comprising:
curing the first facesheet, the plurality of core segments, and the second facesheet together to form a unitary core assembly; and
forming a casing surrounding the second facesheet using an automated fiber placement (AFP) process.

8. A method in accordance with claim 1, wherein forming a casing comprises forming a casing surrounding the core segments using an automated fiber placement (AFP) process.

9. A method of forming a composite containment casing assembly comprising:
forming a first annular radially inner facesheet;
installing a core surrounding the facesheet forming a core assembly;
forming a radially outer casing surrounding the core;
curing the casing assembly.

10. A method in accordance with claim 9, wherein forming a first annular radially inner facesheet using an automated fiber placement (AFP) process.

11. A method in accordance with claim 9, wherein forming a radially outer casing comprises forming a radially outer casing surrounding the core using the AFP process.

12. A method in accordance with claim 9, wherein installing a core surrounding the facesheet comprises forming a core assembly wherein the core assembly includes one or more core layers, each core layer comprising any of a cell configuration, a columnar configuration, or a truss configuration.

13. A method in accordance with claim 9, further comprising:
forming a second annular facesheet surrounding the core; and
curing the first facesheet, the core, and the second facesheet together to form a core assembly.

14. A composite containment casing system comprising:
a first radially inner annular facesheet layer configured to surround a gas turbine engine duct;
a core assembly surrounding said facesheet layer; and
a casing structure wound around the core assembly, said facesheet layer, core assembly, and said casing structure cured together to form a unitary containment casing system.

15. A system in accordance with claim 14, wherein said core assembly comprises a plurality of core segments that comprise a plurality of core layers.

16. A system in accordance with claim 14, wherein each of the plurality of core layers comprising any of a cell configuration, a columnar configuration, a truss configuration, or combinations thereof.

17. A system in accordance with claim 14, wherein said core assembly comprises a second annular radially outer factsheet layer surrounding said plurality of core segments.

18. A system in accordance with claim 14, wherein said first facesheet comprises a circumferential recess configured to receive an abradable material.

19. A system in accordance with claim 14, wherein said first facesheet comprises a pre-impregnated composite material.

20. A system in accordance with claim 14, wherein said casing structure comprises a pre-impregnated composite material.
